(19) United States
(12) Patent Application Publication
(10) Pub. No.: US 2005/0144576 A1
(43) Pub. Date: Jun. 30, 2005

(54) Design method for semiconductor circuit device, design method for semiconductor circuit, and semiconductor circuit device

(75) Inventors: Hiroshi Furuta, Kanagawa (JP); Kenjyu Shimogawa, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/019,634

(22) Filed: Dec. 23, 2004

(30) Foreign Application Priority Data
Dec. 25, 2003 (JP) 2003-429340

(51) Int. Cl. G06F 17/50

(52) U.S. Cl. 716/4; 716/1

(57) ABSTRACT

In one embodiment of the present invention, in a discrete MOSFET, the ZTC point is determined by combining the variation of the drain current induced by the variation of the threshold voltage in response to the temperature and the variation of the drain current induced by the variation of the mobility in response to the temperature. The chips configured with a number of circuits, however, include the circuits whose main operation regions of the MOSFETs are different. In CMOS circuits, the MOSFETs operate in the saturation region. On the other hand, in analog circuits, such as sense amplifiers or bandgap circuits, the MOSFETs operate in the linear region. In the design of the temperature dependence of the chip, the design is achieved by independently different models for respective MOSFETs whose operation regions are different.

### BACKGROUND OF THE INVENTION

1. Field of the Invention

This invention relates to a semiconductor circuit device and a design method for a semiconductor circuit device, particularly to controlling the temperature dependence of designated characteristics of a semiconductor circuit.

2. Description of Related Art

The temperature dependence is one of the important design factors for semiconductor integrated circuits. Some semiconductor circuits whose characteristics do not depend on the temperature are known. For example, when a temperature-independent reference voltage source is required in CMOS circuits, the circuit referred to as a bandgap reference circuit is used. The temperature-independent reference voltage is obtained by taking advantage of the negative linear dependence of the potential of a p-n junction to the absolute temperature at a constant bias current and the proportional relation between the absolute temperature and the potential difference between two p-n junctions biased with different current densities.

In addition to the above-mentioned circuit, it is known that the temperature-independent circuit is designed by using the ZTC (Zero Temperature Coefficient) in a MOSFET. In MOSFETs, the phenomenon that the drain current does not depend on the temperature under the particular bias conditions is known. This bias point is generally referred to as a ZTC bias point. For example, a design method for eliminating the temperature dependence of the delay time in the inverter circuit using the ZTC is proposed in “Supply Voltage Scaling for Temperature Insensitive CMOS Circuit Operation”, A. Bellaour, et. al., IEEE Tran. Circuits and Systems, pp. 415-417, 1998. Or applying the ZTC effect to constant voltage generating circuits is proposed in “Mutual Compensation of Mobility and Threshold Voltage Temperature Effects with Applications in CMOS Circuits” I. M. Filanovsky, et. al., IEEE Transactions on Circuits and Systems-I: Fundamental Theory and Applications, vol. 48, pp. 876-884, 2001.

Measurement results of the temperature characteristics of an actual product are disclosed in “Reversal of Temperature Dependence of Integrated Circuits Operating at Very Low Voltages”, C. Park, et. al., 1995 International Electron Devices Meeting TECHNICAL DIGEST pp. 71-74. It indicates that there exits a power source voltage at which the operating speeds of the CPU and the SRAM do not depend on the temperature and this power source voltage coincides with the voltage which is the ZTC point (where the drain voltage is equal to the gate voltage) of the NMOSFET in the CPU, and also, coincides with the ZTC point of the PMOSFET in the SRAM. The analytical equations for the ZTC of analog circuits and digital circuits have been introduced in “Zeroing in ON a Zero-Temperature Coefficient Point”, I. M. Filanovsky, et. al., Circuit and System, 2002, MWCAS-2002, the 2002 45th Midwest Symposium on, Vol. 1, Aug. 4-7, 2002, pp. 271-274. The discussion on the digital circuits has been made by referring to the above C. Park's paper. It is disclosed that the ZTC bias point has a temperature dependence on the gate length of the MOSFET, and also the results of the measurement of the ZTC conditions in an inverter circuit are disclosed in “Temperature-Independence-Point Properties for 0.1 um-Scale Pocket-Implant Technologies and the Impact on Circuit Design” K. Hisamitsu, et. al., Design Automation Conference, 2003, Proceedings of the ASP-DAC 2003, Asia and South Pacific, 21-24 Jan., 2003, pp. 179-183.

As described above, for a MOSFET or a specific circuit, it is known that the temperature dependent coefficient is reduced to zero using the ZTC. It is also known that there exits a power supply voltage at which the operating speed is free from temperature dependence. Regarding the control of the temperature dependence on a chip level, however, the concrete examinations have not been made from the design phase to the manufacturing phase.

It has now been discovered that, when designing the temperature dependence on a chip level which is configured with a number of different kinds of circuits, the semiconductor circuits with required circuit characteristics cannot be designed by mere usage of the ZTC limited to only some partial elements referred in the prior arts. In particular, it is difficult to estimate the operation margin and predict the temperature dependence of the output in a circuit processing the signals from functional circuits whose temperature dependent coefficients are of different signs (positive and negative). The same difficulty occurs on a system board. In a system with high speed operation, for example, it is more likely to occur that the temperature characteristics do not meet the specifications.

### SUMARY OF THE INVENTION

An embodiment of the invention is a method for designing a semiconductor circuit device. It determines a MOSFET of which main operating region is a linear region and a MOSFET of which main operating region is a saturation region. It determines a threshold voltage of the MOSFET of which main operating region is a linear region according to a first rule for controlling a temperature dependence of the MOSFET of which main operating region is a linear region, and determines a threshold voltage of the MOSFET of which main operating region is a saturation region according to a second rule different from the first rule for controlling a temperature dependence of the MOSFET of which main operating region is a saturation region.

Another embodiment of the invention is a method for designing a semiconductor circuit device including a plurality of functional circuit blocks. It sets threshold voltages of MOSFETs in a first functional circuit block to make a temperature dependence coefficient of an operating characteristic of the first functional circuit block a predetermined value. It sets threshold voltages of MOSFETs in a second functional circuit block independently of the first functional circuit block to make a temperature dependence coefficient of an operating characteristic of the second functional circuit block a predetermined value.

Another embodiment of the invention is a method for designing a semiconductor circuit device including a NMOSFET and a PMOSSFET. It determines a NMOSFET threshold voltage such that a temperature dependence coefficient of an operating characteristic is a predetermined value and determines a PMOSFET threshold voltage such that the temperature dependence coefficient of an operating characteristic is a predetermined value. An upper limit of the upper absolute threshold voltage of the NMOSFET and the PMOSFET is defined by a condition regarding processing speed, and a lower limit of the lower absolute threshold voltage of the NMOSFET and the PMOSFET is defined by a condition regarding power consumption.

Another embodiment of the invention is a semiconductor circuit device. It comprises a plurality of functional circuit blocks and a circuit adjusting a temperature dependence coefficient of an operating characteristic of a functional circuit block to a predetermined value.

### BRIEF DESCRIPTION OF THE DRAWINGS

The above and other objects, advantages and features of the present invention will be more apparent from the following description taken in conjunction with the accompanying drawings, in which:

FIG. 1 is a graph illustrating the temperature characteristics of a MOSFET for explaining the ZTC of the present embodiment.

FIG. 2 is a flowchart showing one of the design methods of a chip in accordance with the present embodiment.

FIG. 3 is a flowchart showing one of the design methods of a chip in accordance with the present embodiment.

FIG. 4 shows the relation between the performance and the power consumption, and the threshold of the MOSFET in accordance with the present embodiment.

FIG. 5 is a block diagram showing one example of the function blocks in a memory in accordance with the present embodiment.

FIG. 6 shows the temperature characteristics of the timer circuit in the memory in accordance with the present embodiment.

FIG. 7 is a block diagram showing the functional circuit block having the switch-selectable reserve circuit in accordance with the present embodiment.

FIG. 8 is a block diagram showing the functional circuit block having the threshold control block of the MOSFET in accordance with the present embodiment.

FIG. 9 is a circuit diagram showing one example of the threshold control block of the present embodiment.

FIG. 10 is a block diagram showing the chip having an internal voltage generator block operative to generate the variable internal voltages in accordance with the present embodiment.

### DESCRIPTION OF THE PREFERRED EMBODIMENTS

In the design of the chip or the semiconductor circuit device according to the present embodiment, or in the semiconductor circuit device manufactured according to the design method above, the zero temperature effect in a MOSFET is used in order to effectively set or control the temperature dependence of the semiconductor circuit device. In the operation of the MOSFET, there is a point where substantially no temperature dependence of the drain current is observed. This point is generally known as the ZTC (zero temperature coefficient) point. First, the ZTC point is explained below.

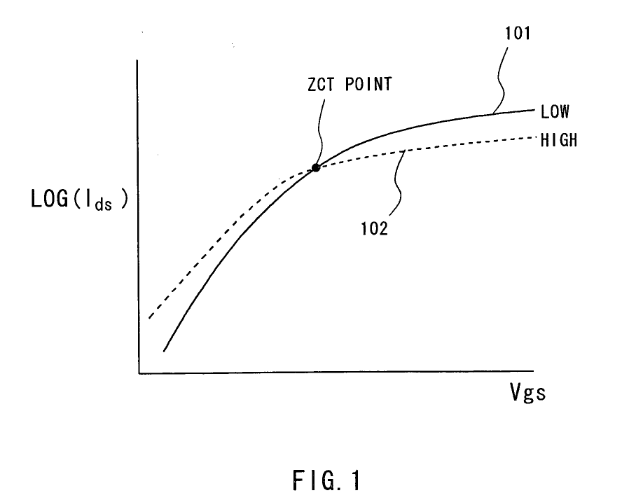

FIG. 1 is a graph showing the relation between the gate voltage (Vgs) and the drain current (Ids) in a MOSFET. In FIG. 1, the X axis represents the gate voltage (Vgs), and the Y axis represents the drain current (Ids), where the drain current Ids is represented with logarithm scale. In FIG. 1, the curve 101 represents the relation between the gate voltage and the drain current at a low temperature (e.g., an ambient temperature), and the curve 102 represents the relation between the gate voltage and the drain current at a high temperature. The intersection of the two curves is the ZTC point.

It is known that the drain current of the MOSFET includes the drift current component and the spread current component. The spread current component mainly contributes to the drain current in the sub-threshold region or the impartial inversion region at the low gate voltage. The spread current component has a positive temperature dependence (positive temperature coefficient) which increases according to the temperature increase, and the threshold voltage is lowered with the temperature increase. In the linear region or the saturation region, the drift current component mainly contributes to the drain current. The drift current component has a negative temperature dependence (negative temperature coefficient) which decreases according to the temperature increase. This is because the phonon scattering is increased by the temperature increase, and the mobility of the carriers is then decreased. As mentioned above, the drain current Ids of the MOSFET represents the different temperature dependence for the low gate voltage and the high gate voltage, so that there is a point where the temperature dependence of the drain current Ids is minimized, that is, there is a ZTC point where no temperature dependence is observed.

Here, with the analysis of the MOSFET, the explanation is provided on the phenomenon that there is a ZTC point where substantially no temperature dependence of the drain current is observed. The drain current Ids of the MOSFET is expressed by the following equations.
Ids=μ(T)[Vgs−V_{T}(T)]^{α}
V_{T}(T)=V_{T}(T₀)−N(T−T₀)
μ(T)=μ(T₀)(T/T₀)^{-M} [Equation 1]

In these equations, μ is the mobility, and VT is the threshold voltage. These are the function of the temperature. Coefficient α is the index number of a term indicating the dependence of the drain current Ids on the gate voltage (Vgs). N is the absolute value of the temperature dependent coefficient of the threshold voltage, having the unit of [mV/K]. Coefficient M is the index number of a term indicating the temperature dependence of the mobility μ. In these equations, all the coefficients are of positive values. T0 is a predetermined temperature such as an ambient temperature. These definitions are hereafter applied to the equations in the present application. By differentiating the drain current Ids by the temperature T, the following equation is derived.
∂Ids/∂T=[∂μ(T)/∂T][Vgs−V_{T}(T)]^{α}+μ(T)∂[Vgs−V_{T}(T)]^{α}/∂T=(−M)*μ(T₀)*T₀^{M}*T^{-M-1}[Vgs−V_{T}(T₀)+N(T−T₀)]^{α}+μ(T₀)*T₀^{M}T^{-M}*N*α*[Vgs−V_{T}(T₀)+N(T−T₀)]^{α-1} [Equation 2]

When the result of the above equation is zero, the drain current Ids show no temperature dependence.
(M)*T⁻¹=N*α*[Vgs−V_{T}(T₀)+N(T−T₀)]⁻¹
Vgs=V_{T}(T₀)+(α*N*T)/M−N(T−T₀) [Equation 3]

Thus, the solution of this equation provides the point where the temperature dependence of the drain current Ids is minimized. If T=T₀, the above equation is expressed as below.
Vgs=V_{T}(T₀)+(α*N*T₀)/M [Equation 4]

By satisfying this condition, the temperature dependence of the drain current is substantially eliminated. The description above is the analytical explanation of the phenomenon that the temperature dependence of the drain current Ids in the MOSFET is reduced to zero.

As described above, in a single MOSFET, the ZTC point is determined by the combination of changes of the drain current induced by the change of the threshold voltage depending on the temperature and induced by the change of the mobility depending on the temperature. The chip, i.e., a semiconductor circuit device configured with a number of circuits, however, includes circuits whose main operation regions of the MOSFETs are different from each other.

That is, in the CMOS circuit incorporated in the semiconductor circuit device, the MOSFETs of the inverter circuit operate in the saturation region. On the other hand, in the circuit of the analog operation such as a sense amplifier or a bandgap circuit, the MOSFETs operate in the linear region. Thus, in controlling the temperature dependence in the chip design, it is important to design the chip based on the independently different models or rules for each group of MOSFETs classified by their operation regions.

First, an explanation is provided on one of the preferred embodiments directed to the approach for designing the MOSFET which operates mainly in the saturation region. The exemplary dimension of the MOSFET and the power supply voltage of a product chip are determined along with a design rule. Further, the specifications of the chip are determined. In order to control the temperature dependence of the performance of the chip (an operation characteristic), the conditions for a single MOSFET and so on are determined as described below. First, the coefficients α, N and M in the following equations are determined for the single MOSFET. For example, the temperature dependences of both NMOSFET and PMOSFET are measured by TEG (Test Element Group) measuring, and the parameters to respective MOSFETs are determined.
Iav=μ(T)[V_{DD}−V_{T}(T)]^{α}
V_{T}(T)=V_{T}(T₀)−N(T−T₀)
μ(T)=μ(T₀)(T/T₀)^{-M} [Equation 5]

VDD is power supply voltage. Circuits operative in the saturation region are implemented in digital circuits. Most of circuits operative in the saturation region are generally configured with inverter circuits. In the operation of NAND circuits and NOR circuits, the main operation regions are the saturation region as well as the case of inverter circuits. Accordingly, the condition where the characteristics of the inverter circuit do not depend on temperature is determined. The condition under which the delay time td is not affected by the temperature variation is determined, where td is the delay time of the inverter circuit.
t_{d}=C_{L}*V_{DD}/2*Iav
Iav=(Idn+Idp)/2=(μn(T₀)(T/T₀)^{-Mn}*[V_{DD}−V_{Tn}(T₀)−Nn(T−T₀)]^{αn}+μp(T₀)(T/T₀)^{-Mp}*[V_{DD}−V_{Tp}(T₀)−Np(T−T₀)]^{αp})/2 [Equation 6]

In the equation above, n and p represent the terms for characteristics of the NMOSFET and the PMOSFET respectively. CL is the capacity of the load.
Un=μn(T₀)*T₀^{Mn} Up=μp(T₀)*T₀^{Mp}
Vn=V_{DD}−V_{Tn}(T₀) Vp=V_{DD}−V_{Tp}(T₀) [Equation 7]

Under the conditions above, Un, Up, Vn and Vp become temperature-independent terms.
2*Iav=Un*T^{-Mn}*[Vn+Nn(T−T₀)]^{αn}+Up*T^{-Mp}*[Vp+Np(T−T₀)]^{αp} [Equation 8]

By differentiating the delay time td of the inverter circuit by the temperature T according to the equation above, the following equation is obtained.
∂t_{d}/∂T∝∂Iav⁻¹/∂T=Un⁻¹*(Mn)*T^{Mn-1}*[Vn−Nn(T−T₀)]^{-αn}+Un⁻¹*T^{Mn}*(−αn)*Nn*[Vn+Nn(T−T₀)]^{-αn-1}+Up⁻¹*(Mp)*T^{Mp-1}*[Vp−Np(T−T₀)]^{-αp}+Up⁻¹*T^{Mp}*(−αp)*Np*[Vp+Np(T−T₀)]^{-αp-1} [Equation 9]

The condition that there is no temperature dependence of the delay time td is derived as below.
∂t_{d}/∂T∝∂Iav⁻¹/∂T=0 [Equation 10]

Both rise and fall time of the inverter should be temperature independent. Thus, the condition is determined where the terms of both the NMOSFET and the PMOSFET are zero. The condition where the terms related to the NMOSFET become zero is derived as below.
Un⁻¹*(Mn)*T^{Mn-1}*[Nn−Un(T−T₀)]^{-αn}=Un⁻¹*T^{Mn}*(αn)*Nn*[Vn+Nn(T−T₀)]^{-αn-1}
Mn*[Vn−Nn(T−T₀)]=αn*Nn*T
Vn=(αn/Mn)*Nn*T+Nn*(T−T₀)=V_{DD}−V_{Tn}(T₀)
∴V_{DDn}=V_{Tn}(T₀)+(αn/Mn)*Nn*T+Nn*(T−T₀) [Equation 11]

The condition where the terms related to the PMOSFET become zero is similarly derived as below.
V_{DDP}=V_{Tp}(T₀)+(αp/Mp)*Np*T+Np*(T−T₀) [Equation 12]

Given that VDDn=VDDp in the typical products, and that the typical temperature under the operation environment for the CMOS is an ambient temperature, that is, T=T0=300K, the following equation is reasonably derived.
V_{Tn}(T₀)+(αn/Mn)*Nn*T₀=V_{Tp}(T₀)+(αp/Mp)*Np*T₀ [Equation 13]

The relation between VTn(T0) and VTp(T0) is determined by Equation 13, VDD is then determined by using VTn(T0) or VTp(T0). Alternatively, the threshold voltages VTn(T0) and VTp(T0) are determined so that both MOSFETs meet the equation above in which VDD has already been determined by the design standard in view of performance and liability. Each ZTC is set for the NMOSFET and the PMOSFET.

Based on the model above, by designing the inverter circuit operative in the saturation region, the temperature dependence is effectively controlled in the circuit included in the chip. By using the model above, the temperature dependence is minimized, or the chip is designed so that there is substantially no temperature dependence for the inverter circuit, that is, the temperature dependent coefficient is zero. Alternatively, the MOSFET having a predetermined positive or negative temperature dependent coefficient is easily designed by shifting the value from the ZTC point.

In addition, the threshold voltage of the MOSFET is controlled by, for example, changing the ion injection to a substrate of the uniform channel dopant or non-uniform channel dopant, in other words, setting the non-uniformity of the substrate channel dopant. It is also important to set the proper threshold voltage to the gate length for each MOSFET, because the ZTC point varies with the gate length. The same are also applied to the following discussion.

Next, one of the preferred embodiments is explained with regard to the approach for the design controlling the temperature dependence in the circuit operative in the linear region, such as the analog circuit like a sense amplifier. The drain current of the MOSFET in the linear region is expressed as follows.
Ids=β*[Vgs−V_{T}−0.5*a*Vds]*Vds [Equation 14]

In this equation, “a” is a constant determined by the device structure and the Vds is the drain voltage. The condition where the drain current Ids has no temperature dependence is expressed as the following equation.
∂Ids/∂T∝∂└μ(T₀)(T/T₀)^{-M}*[V_{DD}−V_{T}(T₀)−N(T−T₀)−0.5*a*Vds]Vds┘/∂T=
(−M)*μ(T₀)(T/T₀)^{-M-1}*[V_{DD}−V_{T}(T₀)−N(T−T₀)−0.5*a*Vds]Vds+μ(T₀)(T/T₀)^{-M}*(−N)*Vds [Equation 15]

If T=T0, the following equation is derived.
Vgs=V_{T}(T₀)+0.5a*Vds−(N*T₀)/M [Equation 16]

In Equation 14, for example, Vds and Vgs are predetermined, which are important for the operation, and then, the threshold voltage VT corresponding to these values is determined. As mentioned, by setting the threshold voltage to a specific value, the MOSFET with the minimized temperature dependence is designed for the MOSFET operative in the linear region. As described above, by designing the circuit operative in the linear region based on the aforementioned model, the temperature dependence of the circuit in the chip is effectively controlled. The control of the temperature dependence allows the temperature dependence to be reduced toward zero, or to be designed to a positive or negative value according to the chip design. The design method based on the model above is useful particularly in the determination of the process conditions in the initial phase of the design.

As described above, in the chip including various types of circuits, an effective MOSFET design regarding the temperature dependence is achieved by designing the MOSFETs based on the respective different models according to their operation regions. The integrated circuit chips, however, have different functions and circuit arrangements according to the products. Thus, the design focusing only on the characteristics of a single transistor or the characteristics of a single transistor in CMOS circuit provides no guarantee of the optimized temperature dependence of the operation characteristics in view of the whole circuit.

Then, some specific methods for designing the chip product are explained. One of the preferred methods is to derive the temperature dependence of the chip by fixing the manufacturing conditions (characteristics) for one of the types of NMOSFET and PMOSFET, and changing the manufacturing conditions (characteristics) for the other type of MOSFET. These steps are processed for both transistors respectively, resulting in the proper determination of the manufacturing conditions (characteristics) for both transistors.

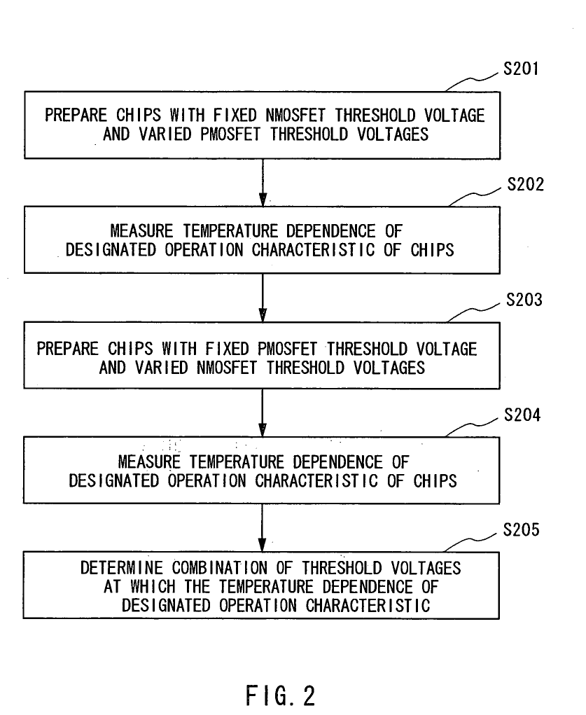

The embodiment is specifically explained as follows. In this embodiment, the explanation is provided for the proper design method of the temperature dependence of a predetermined characteristic in a chip product by setting the proper threshold voltage of the transistor. Referring to FIG. 2, a plurality of chips in the form of TEG or product are prepared (Step 201), in which the NMOSFETs have the fixed characteristics and the PMOSFETs have the varied threshold voltages. That is the NMOSFETs have the same threshold voltages between each chip, while the PMOSFETs have the different threshold voltages between each chip. Each threshold voltage, for example, can be determined based on the threshold voltage at an ambient temperature, where the ambient temperature is the reference temperature. The threshold voltages of the NMOSFETs or selected different threshold voltages of a plurality of PMOSFETs are determined according to the analytical model described above. The characteristic coefficients that are required for the determination of the threshold voltages have been determined for respective single transistors by measurement.

Next, the temperature dependences for the designated operation characteristic is measured for respective provided chips (Step 202). The appropriate designated operation characteristic is selected for the circuit arrangement, such as the processing performance for the base clock in a processor, the access speed of the memory, and so on. Then, a plurality of chips in the form of TEG or a product are prepared (Step 203), in which the PMOSFETs have the fixed characteristics and the NMOSFETs have the varied threshold voltages. Similarly to above, the temperature dependences for the designated operation characteristic of the respective provided chips are measured (Step 204). It is noted that the order of the steps above may be changed as required.

The combination of the threshold voltages of the NMOSFET and the PMOSFET which meets the desired temperature dependence for the designated operation characteristic is determined. This is determined based on the temperature dependences of the operation characteristics of the chips in both cases where the characteristics (including the threshold voltage) of the NMOSFETs have been fixed and the threshold voltages of the PMOSFETs are varied, and where the characteristics (including the threshold voltage) of the PMOSFETs have been fixed and the threshold voltages of the NMOSFETs are varied. For example, the threshold voltages which minimize temperature dependence of the operation characteristics are determined for the NMOSFETs and the PMOSFETs (Step 205). This allows the proper chip design of the temperature dependence of the product. In addition, if there is a combination which meets the desired temperature dependent coefficient in the combinations of the measured threshold voltages, that combination is applied. If not, the optimal combination of the threshold voltages can be determined by calculating or estimating from the measured threshold voltages. The same is also applied to the following description.

In the description above, the optimal combination of the threshold voltages is determined by fixing the threshold voltages of one type of the transistors and changing threshold voltages of the other type of the transistors. It is also possible to determine the optimal combination of the threshold voltages using a matrix of the threshold voltages of NMOSFETs and PMOSFETs. This means that a plurality of threshold voltages are set as the fixed threshold voltages for one or both of the PMOSFETs and the NMOSFETs.

For example, a plurality of threshold voltages are selected for the PMOSFETs and the NMOSFETs respectively. The TEG or products which satisfy the combinations of respective threshold voltages are prepared. The temperature dependent coefficients of the designated operation characteristics for respective circuit units are measured, then, the combination of the optimal threshold voltages is determined so that the designated characteristics have the desired temperature dependent coefficients. With regard to the combinations of the threshold voltages in the matrix, for example, it is preferable to select high, medium and low threshold voltages for each of the PMOSFETs and the NMOSFETs, and measure more than nine combinations, namely, [high, medium, low] by [high, medium, low].

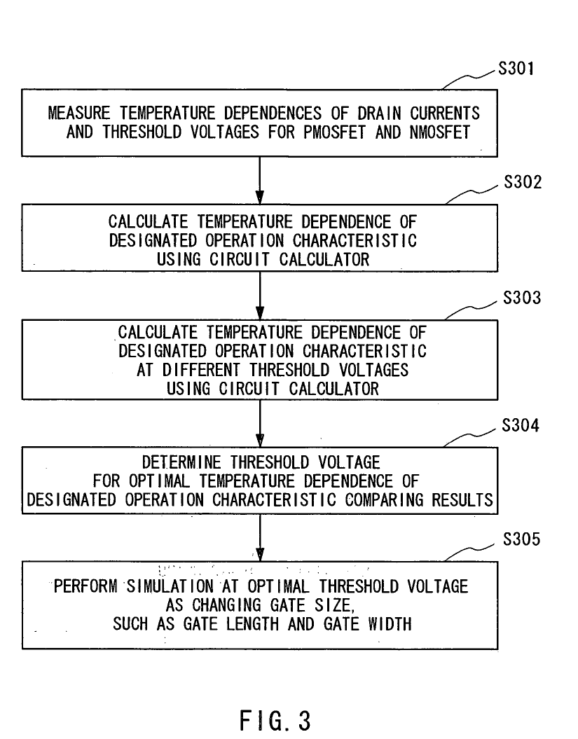

In the chip design, it is preferable to employ the design method with the circuit simulator as well as the measurement of the TEG or product described above. Next, one of the preferred embodiments for the design method which employs the circuit simulator is explained by referring to the flowchart of FIG. 3. First, the temperature dependences of the drain current and the threshold voltages are measured for a single PMOSFET and a single NMOSFET (Step 301) to provide them to the circuit simulator.

It is preferable to measure the temperature dependences of the drain current and the threshold voltages for a plurality of transistors whose threshold voltages at the reference temperature (e.g., at an ambient temperature) are different among each other. In order to reduce the number of measurement steps and the load for completing the simulation model, it is also acceptable to measure the temperature dependence of the drain current and the threshold voltage for one threshold voltage which is properly selected. From one set of data related to the threshold voltage, the temperature dependences for different threshold voltages can be calculated by the simulator. For the determination of the threshold voltage above, the analytical model as explained above can be applied.

Next, by using the results of the measurement, the temperature dependence of the designated operation characteristic of the chip as a product, is calculated by the circuit simulator (Step 302). Then, the threshold voltage is changed and the temperature dependence of the designated characteristic of the product (chip) is calculated for the transistor structure having different threshold voltage at the reference temperature (Step 303). By repeating the process of Step 303, the temperature dependences for the designated characteristic are calculated for a plurality of different threshold voltages.

Then, the results of the calculation on the operation characteristics at the different threshold voltages obtained by changing the threshold voltage are compared to determine the threshold voltage which achieves the optimal temperature dependence for the designated characteristic of the product (Step 304). The threshold voltage may be set to have the minimum or a zero temperature dependent coefficient, or a desired positive or negative temperature dependent coefficient of the designated characteristic. The optimal threshold voltage is obtained, for example, by graphically plotting the relation between the threshold voltage and the temperature dependence based on the calculated results of the temperature dependent coefficient of the operation characteristic obtained for a plurality of threshold voltages.

Last, at the optimal threshold voltage determined in Step 304, the simulation is performed with changing the gate size, such as gate length and the gate width (Step 305). This step determines the gate size which allows the desired characteristics of the chip. In addition, since the ZTC of the circuit varies with the gate size, it is preferable to repeatedly perform the simulation on the threshold voltage under the condition that the gate size is changed, if necessary. If the desired characteristics cannot be obtained by setting the gate size, it will be possible to obtain it by changing the threshold voltage. In this case, the threshold voltage is selected so that the temperature dependence for the designated characteristic of the circuit matches the desired setting. It is noted that, while the embodiment is exemplified by the arrangement including both PMOSFETs and NMOSFETs, the design method above can be applied to the circuit with the arrangement including one type of the transistors.

In the determination of the threshold voltage of the transistor, it is preferable to evaluate the value of the designated operation characteristics or the power consumption, or both of them as well as the temperature dependence for the designated operation characteristic. For example, in the case where the threshold voltage is determined to minimize the temperature dependence for the designated operation characteristic, it is possible to calculate the threshold voltage of the MOSFET using the circuit simulator so that the designated operation characteristics becomes the best value, the power consumption is minimized, or both of them are included in an appropriate range. The explanation of this point, particularly for the inverter circuit, is provided below.

By referring to Equation 13, the relation between the threshold voltages of the PMOSFET and the NMOSFET is discussed. In prevalent planer type MOSFETs whose gate length are around 0.1 μm, the temperature dependences of the mobility are different between the holes and the electrons, thus, the relation between αn/Mn and αp/Mp becomes αn/Mn<αp/Mp due to the relation of αn<αp and Mn>Mp. Nn and Np are assumed to be substantially the same value. Accordingly, in Equation 13, it is required that VTn(T0) of the NMOSFET be higher than VTp(T0) of the PMOSFET. There, however, is a possibility that the future modification to the MOSFET structures may reverse this relation between these thresholds.

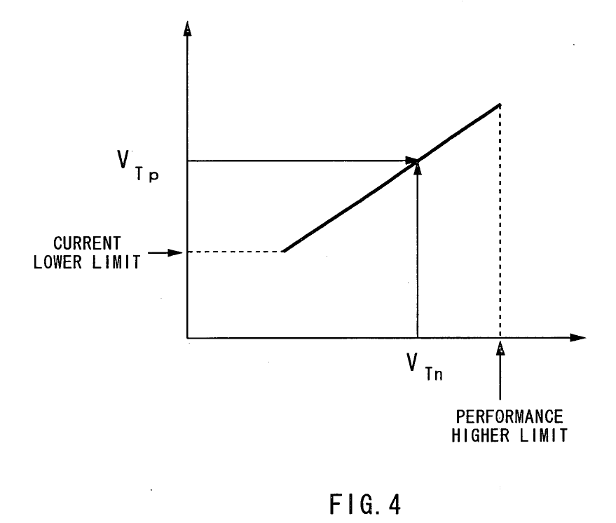

The higher threshold voltage causes the lowered performance, while the lower threshold voltage causes the increased leak current. From this point, in the prevalent planer type MOSFETs whose gate length are around 0.1 μm, it is understood that the operation speed in the circuit is controlled by the NMOSFET, and the power consumption is affected by the PMOSFET. Thus, it is preferable to take all these points into account in the determination of the threshold voltages of the PMOSFET and the NMOSFET. FIG. 4 shows the above-mentioned relations. As indicated in the analytical model, the relation between VTn and VTp at the ZTC is expressed by Equation 13. By determining the drain voltage, VTn and VTp are uniquely determined. While, there is a possibility of the reversed relation between the threshold voltages of NMOSFET and PMOSFET due to the particular MOSFET structure, the same concept as above is applied to the case of the reversed relation.

As mentioned above, in the determination of the threshold voltage when designing the circuit, it is important that VTn and VTp are determined so that the performance and the power consumption of the product satisfy the requirements. It is preferable that the upper limit of the upper threshold voltage of the NMOSFET and PMOSFET is defined in terms of the performance, and the lower limit of voltage the lower threshold voltage of the NMOSFET and PMOSFET is determined according to the condition for the current specification (power consumption). The same is similarly applied to the design with measurement as well as the design with simulation.

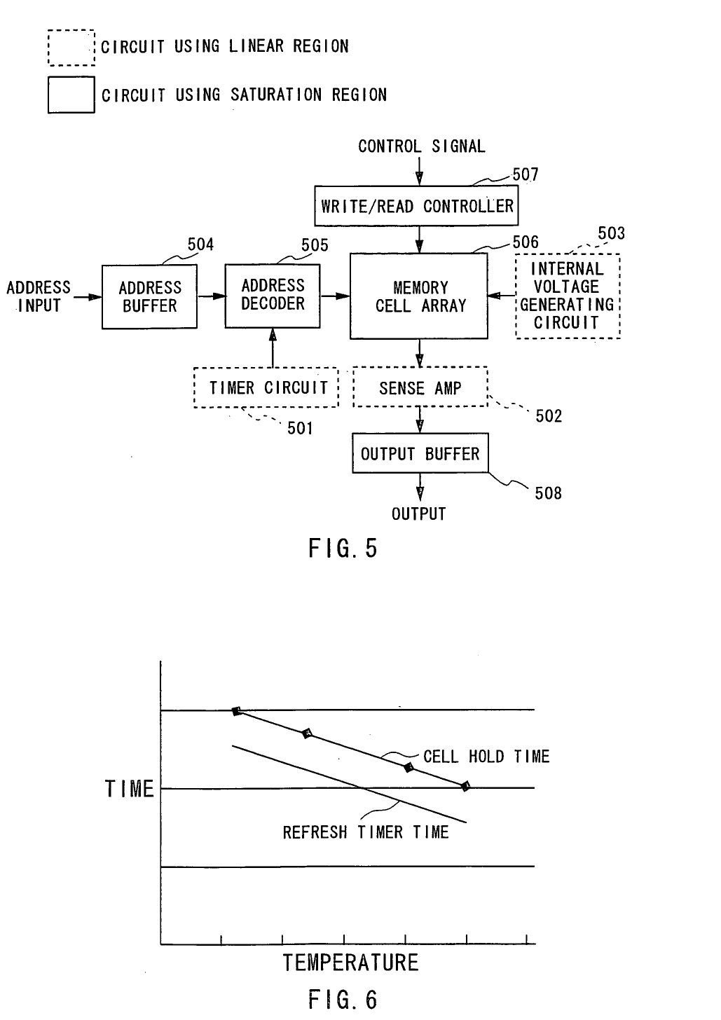

In the chip design, one of the preferable design methods for controlling the temperature dependence for the designated operation characteristics is to design a chip from functional circuit block to functional circuit block. The design values, such as operation voltage, the threshold voltage of the MOSFET, the gate size, and so on, are determined for each functional circuit block configuring the whole chip. FIG. 5 shows, in an example of a memory, an exemplary arrangement of the functional circuit block formed in a chip. The memory 500 comprises the functional circuit blocks (dotted boxes) in which the MOSFETs of the circuits mainly operate in the linear region, and the function functional circuit blocks (solid boxes) in which the MOSFETs of the circuits mainly operate in the saturation region. In FIG. 5, the functional circuit blocks operative in the linear region comprises a timer circuit 501, a sense amplifier 502, and an internal power voltage generating circuit 503. On the other hand, the functional circuit blocks operative in the saturation region comprises an address buffer 504, an address decoder 505, a memory array 506, a write/read controller 507 and an output buffer 508. The timer circuit 501 is used particularly in the case of the DRAM.

In the design of the circuit, it is possible to determine the characteristics (manufacturing conditions) of the MOSFETs on a functional circuit block basis according to the design method described above. One or some specific operation characteristics are selected for the selected functional circuit block, and then, the temperature dependent coefficients of the operation characteristics are designed to match the desired values. For example, the threshold voltage of the MOSFET is determined to have substantially no temperature dependence of an operation characteristic. It is possible that each functional circuit block is designed to have substantially no temperature dependence of a designated operation characteristic, and lastly, the thresholds of the MOSFETs are adjusted as required in order to have substantially no temperature dependence of the whole chip for the designated operation characteristic.

As described above, in the design of the circuit, it is possible not only to design the MOSFET or its operation conditions which have the minimized temperature dependent coefficient or substantially no temperature dependence for the designated characteristics, but also to design the MOSFET which has a desired positive or negative temperature dependent coefficient for the designated operation characteristics. For example, if the memory 500 is a DRAM, the timer circuit 501 is designed so that the refresh time is decreased (shorten) with the increase of temperature. FIG. 6 shows the preferable relation between the hold time of a memory cell and the refresh time controlled by the timer circuit 501. In FIG. 6, the X and Y axes represent the temperature and time respectively.

The memory cell array 506 has negative temperature dependence. The hold time of the memory cell array 506 decreases as the temperature increases because the leak current increases with the temperature increase due to the characteristics of the circuit. If the refresh time is too long for the hold time, the memory data is not held. On the other hand, the shorter refresh time causes the increased current. Thus, the negative temperature coefficient of the refresh time contributes to the stabilized operation of the memory. As described above, the temperature dependence of the operation characteristics is controlled, for example, by changing the threshold voltage of the MOSFET. The threshold voltage which allows the desired temperature dependence for the operation characteristics is determined, for example, by determining the threshold voltage of the temperature-independent point and changing the threshold voltage from that voltage.

Another preferred embodiment has the first functional circuit with a negative temperature dependence coefficient and the second with a positive temperature dependence coefficient. The first and second functional circuits cancel the temperature dependence with each other accomplishing a circuit independent of the temperature change as a whole. For example, a sense amplifier amplifies the read signal amplitude of bit lines. It is necessary to delay the activation timing of the sense amplifier as the temperature increase. As the performance of a transfer transistor of a cell decreases as the temperature increases, it is required to compensate it with the delay. In other words, the activation timing of the sense amplifier, as the first functional circuit, has a positive temperature dependence coefficient.

If noting is done, the output speed of data from the output buffer also has a positive temperature dependence coefficient. In this embodiment, the output buffer, as the second functional circuit, has a negative temperature dependence coefficient of the output speed. As a result, the output speed of the data from the output buffer, in other words, the output speed of the entire memory circuit does not substantially depend on the temperature change (i.e., the temperature dependence coefficient as a whole is substantially zero), allowing the stable output speed and data hold time against the temperature change.

In some specific circuits, it is possible to independently design the MOSFET from other circuits. One of the examples is the circuit whose gate voltage and drain voltage are the same, such as a normally-ON transistor. One of the preferred design methods for the circuit with such a characteristic is explained below. First, the threshold voltage VT at the reference temperature (typically an ambient temperature) is selected, then under the condition that the gate voltage and the drain voltage are the same, that is, Vg=Vd, the drain current Id of the MOSFET is measured as changing the temperature.

The drain voltage Vd0 at which drain current Ids shows no temperature dependence is determined. The drain voltages Vd0 which allow no temperature dependence of the drain current Ids are determined for some different threshold voltages VT. Finally, the threshold voltage VT0 corresponding to the drain voltage Vd0 equal to the desired power supply voltage is determined. It is possible to determine VT0 by extrapolating the graph of the drain voltage Vd0 and the threshold voltage VT as required.

The circuit whose drain voltage and gate voltage are constant, such as the transistor in the bandgap circuit, is one of the examples whose MOSFET is designed independently from other circuits. One of the preferred design methods for such a circuit is explained below. First, the temperature variations of the predetermined threshold voltage VT, the gate voltage Vg, the drain voltage Vd and the drain current Ids for a single MOSFET are measured. By changing the drain voltage Vd, the drain voltage Vd0 is determined. At this Vd0, the temperature dependence of the drain current Ids is minimized or reduced to zero (the temperature dependent coefficient is zero) for the predetermined threshold voltage VT and the gate voltage Vg.

Vd0 for each threshold voltage VT is determined by the similar measurement for some different threshold voltages. The threshold voltage VT0 at which Vd0 matches the desired (Vg, Vd) is determined. It is possible to determine VT0 by extrapolating the graph of the drain voltage Vd0 and the threshold voltage VT, if required. The threshold voltage of the transistor is adjusted by, for example, determining the conditions of ion injection so that the threshold voltage VT0 matches the predetermined value.

In the above manner, the drain current Ids with the minimum temperature dependence is determined by fixing the gate voltage Vg to the desired value and changing the drain voltage Vd at a plurality of the selected threshold voltages, then the threshold voltage VT is determined to provide the desired drain voltage Vd. Alternatively, it is also possible to determine the threshold voltage VT to provide the desired gate voltage Vg, by fixing the drain voltage Vd to the desired value and changing the gate voltage Vg, or changing both the drain voltage Vd and the gate voltage Vg.

In the previous paragraph, the circuit is designed to reduce the temperature dependence to substantially zero by setting the different threshold voltages. It is also possible to determine the drain voltage and the gate voltage to reduce the temperature dependent coefficient of the drain current to substantially zero by determining the threshold voltage to the desired value, then measuring the temperature dependence of the drain current at that threshold voltage. The circuit is designed by determining the combination of the drain voltage and the gate voltage, P (Vg, Vd), then, setting the transistor size (e.g., the gate width) so that the bias point of the MOSFET matches the above P(Vg, Vd).

As described above, it is possible to effectively design and control the temperature dependence for the operation characteristics of the product chip by the proper design in a single transistor level, a functional circuit block level, or a chip level. In the manufacturing process, however, the products with the desired characteristics are not necessarily manufactured along with the design because of the manufacturing variations. In view of such the point, it is one of the preferred embodiments to have a redundant circuit embedded in the chip in order to adjust temperature dependent coefficient for the designated operation characteristics to the desired value. For example, it is possible to have the adjustable temperature dependence by pre-arranging the redundant circuit at the input side, output side, or between them in the designated functional circuit block. For example, the connection of the redundant circuit is switched adjust the temperature dependence to substantially zero.

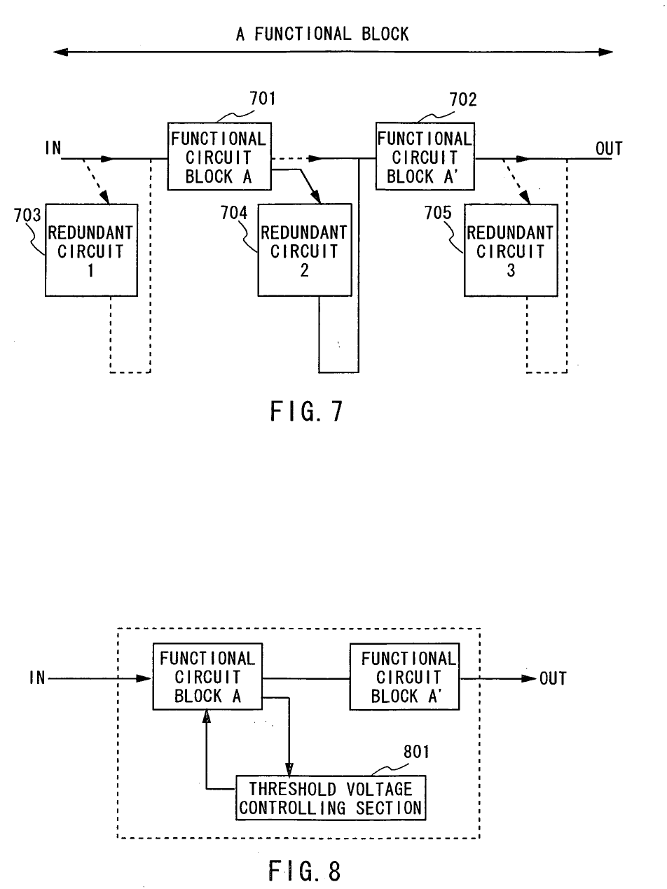

FIG. 7 shows an example in which a plurality of redundant circuits are arranged in one functional circuit block. As shown in FIG. 7, the functional circuit block A (701) and the functional circuit block A′ (702) (functional sub-blocks) are arranged in one functional circuit block. In addition, the redundant circuit 1 (703) is connected between the input and the functional circuit block A, the redundant circuit 2 (704) is connected between the functional circuit block A and the functional circuit block A′, and the redundant circuit 3 (705) is connected between the functional circuit block A′ and the output. FIG. 7 shows the embodiment in which the redundant circuit 2 (704) is used. It is preferable that the size of the redundant circuit is small enough not to affect the chip size.

One exemplary redundant circuit comprises the MOSFET whose size or threshold voltage is different from the function block A, A′, further, resistors, capacitors, and so on. The connections are switched by changing the conductive lines on the upper layer. The lines are changed by changing the mask layout in the manufacturing process, or by changing the upper conductive lines by trimming with laser or electrical cut after forming the chip.

In order to obtain the desired temperature characteristics, it is also preferable to arrange the threshold voltage controlling section 801 in the chip which automatically adjusts and corrects the threshold voltage of the MOSFET, as well as to arrange the switch-selectable redundant circuit. The threshold voltage controlling section 801, for example, monitors the specific transistor in the functional circuit block A to control it so that the temperature dependence of its threshold voltage is maintained to the minimum value. For example, the threshold voltage controlling section 801 controls the threshold voltage of the transistor so that it approaches the desired value, by detecting the variation of the leak current and changing the back bias voltage to the transistor in accordance with the variation of the leak current. This allows, for example, the effective control that gives substantially no temperature dependence to an operation characteristic.

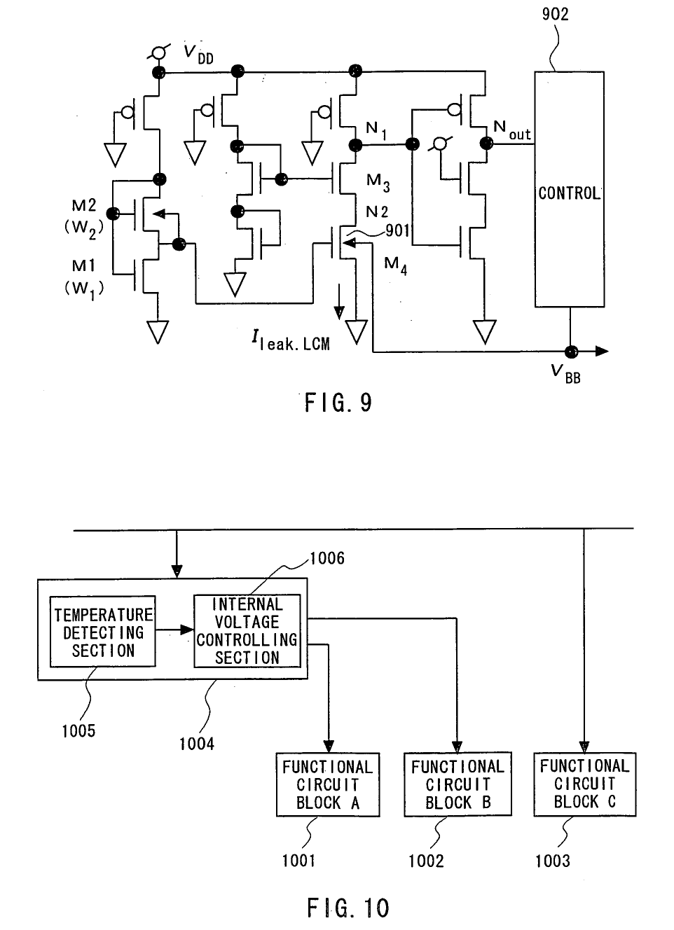

FIG. 9 shows one example of the circuit arrangement that controls the threshold voltage of the specific transistor. In FIG. 9, the transistor M4 is the target for the control. The back bias VBB is supplied to the transistor M4 (901). The threshold voltage is controlled by changing this VBB. For example, the voltage of N1 decreases as the leak current increases. A signal is supplied to the next circuit in response to it, resulting in the inversion of signal Nout from Low to High. The CONTROL 902 lowers the VBB in response to the inputted High Nout signal to decrease the leak current. In this manner, by changing the bias point, the substantial threshold voltage is changed.

As understood from the discussion on the transistor characteristics above, the temperature dependence (ZTC) of the circuit is controlled by controlling the internal voltage in the chip other than by changing the threshold voltage of the transistor. FIG. 10 shows functional circuit blocks A (1001), B (1002) and C (1003) arranged in the chip, and an internal voltage generating circuit block 1004 which supplies the internal voltage to the functional circuit blocks A and B respectively. The internal voltage generating circuit block 1004 is able to generate and supply the different internal voltages to the respective functional circuit blocks A and B from the power supply voltage from the external source.

The internal voltage generating circuit block 1004 comprises a temperature detecting section 1005 which detects the temperature, and an internal voltage controlling section 1006 which changes the internal voltage based on the temperature detected by the temperature detecting section 1005. The circuit arrangements of the respective blocks can be properly designed by adapting well-known circuit arrangements. The internal voltage controlling section 1006 controls the supplying voltage to maintain the temperature dependent coefficient of each functional circuit block at the designed value. For example, the internal voltage controlling section 1006 is able to change the internal voltages for the respective circuit function blocks in response to the detected temperature so that the functional circuit blocks A and B have substantially no temperature dependence for the designated characteristics.

As described above, according to the design method of the present embodiment, it is possible to effectively design the temperature dependence for the designated characteristic in the chip level, and provide substantially no temperature dependence for the designated characteristic of the chip. It is also possible to effectively cope with mass production by arranging the circuit in the chip which compensates the variation caused in the process. The chip having no temperature dependence for a designated characteristic is provided, or the chip with controlled temperature dependence for a designated characteristic is provided, which contributes to the stabled operation of the system including a plurality of chips and the simplified design of the system. Particularly, the future products with lower operation voltage are expected to have chips having the opposite temperature dependent coefficients of the operation speeds on one system (on one printed circuit board). Therefore, the effects achieved by employing the present invention to reduce the temperature coefficients to zero or set all the temperature coefficients to either one of positive or negative value will be more significant to the future products.

It is apparent that the present invention is not limited to the above embodiment and it may be modified and changed without departing from the scope and spirit of the invention.

1. A method for designing a semiconductor circuit device comprising:
determining a MOSFET of which main operating region is a linear region;
determining a MOSFET of which main operating region is a saturation region;
determining a threshold voltage of the MOSFET of which main operating region is a linear region is a linear region according to a first rule for controlling a temperature dependence of the MOSFET of which main operating region is a linear region; and
determining a threshold voltage of the MOSFET of which main operating region is a linear region is a saturation region according to a second rule different from the first rule for controlling a temperature dependence of the MOSFET of which main operating region is a saturation region.

2. The method for designing a semiconductor circuit device of claim 1, wherein the threshold voltages of the MOSFET of which main operating region is a linear region and the MOSFET of which main operating region is a saturation region are determined to bring respective temperature dependences of the drain currents to predetermined values.

3. The method for designing a semiconductor circuit device of claim 2, wherein the threshold voltages of the MOSFET of which main operating region is a linear region and the MOSFET of which main operating region is a saturation region are determined to minimize respective temperature dependences of drain currents.

4. The method for designing a semiconductor circuit device of claim 2, wherein the threshold voltage of the MOSFET of which main operating region is a linear region is determined according to an equation,
Vgs=V_{T}(T₀)+0.5a*Vds−(N*T₀)/M
Vgs: gate voltage, VT: threshold voltage, T0: selected temperature, a: coefficient in accordance with device structure, Vds: drain voltage, N: absolute value of temperature dependent coefficient of the threshold voltage, M: index number of a term indicating temperature dependence of mobility.

5. The method for designing a semiconductor circuit device of claim 4, wherein the threshold voltage of the MOSFET of which main operating region is a saturation region is determined according to an equation,
V_{Tn}(T₀)+(αn/Mn)*Nn*T₀=V_{Tp}(T₀)+(αp/Mp)*Np*T₀
VT: threshold voltage, T0: selected temperature, α: index number of a term indicating gate voltage-dependence of drain current, N: absolute value of temperature dependent coefficient of the threshold voltage, M: index number of a term indicating temperature dependence of mobility (p and n represent terms of PMOSFET and NMOSFET respectively).

6. The method for designing a semiconductor circuit device of claim 2, wherein each of the threshold voltages of the MOSFET of which main operating region is a linear region and the MOSFET of which main operating region is a saturation region is adjusted according to a gate length.

7. The method for designing a semiconductor circuit device of claim 1, wherein the threshold voltages of the MOSFET of which main operating region is a linear region and the MOSFET of which main operating region is a saturation region are adjusted by setting a nonuniformity of channel substrate impurity.

8. The method for designing a semiconductor circuit device of claim 1, wherein an upper limit of an upper absolute value of the threshold voltages of a NMOSFET and a PMOSFET is defined by a condition of an operating characteristic regarding a processing speed and a lower limit of an lower absolute value of the threshold voltages of the NMOSFET and the PMOSFET is defined by a condition of a power consumption.

9. The method for designing a semiconductor circuit device of claim 1, wherein the MOSFET of which main operating region is a linear region is formed in an analog circuit and the MOSFET of which main operating region is a saturation region is formed in a digital circuit.

10. A method for designing a semiconductor circuit device including a plurality of functional circuit blocks, comprising:
setting threshold voltages of MOSFETs in a first functional circuit block to make a temperature dependence coefficient of an operating characteristic of the first functional circuit block a predetermined value; and
setting threshold voltages of MOSFETs in a second functional circuit block independently of the first functional circuit block to make a temperature dependence coefficient of an operating characteristic of the second functional circuit block a predetermined value.

11. A method for designing a semiconductor circuit device of claim 10, wherein a gate voltage and a drain voltage of a MOSFET are equal in the first functional circuit block, and the setting threshold voltages of MOSFETs in a first functional circuit block, comprising:
measuring a temperature dependence of a drain current of a MOSFET at a threshold voltage as changing a drain/gate voltage to derive a drain/gate voltage at which the temperature dependence of drain current is substantially zero;
repeating the measuring a temperature dependence at a different threshold voltage; and
determining a threshold voltage of the MOSFET based on the threshold voltages used for the measuring a temperature dependence and a predetermined threshold voltage.

12. A method for designing a semiconductor circuit device of claim 10, wherein a gate voltage and a drain voltage of a MOSFET are constant in the first functional circuit block, and the setting threshold voltages of MOSFETs in a first functional circuit block, comprising:
deriving a drain and/or gate voltage of a MOSFET at which a temperature dependence of a drain current of a MOSFET is substantially zero by changing the drain and/or gate voltage of the MOSFET at a threshold voltage;
repeating the deriving a drain and/or gate voltage at a different threshold voltage; and
determining a threshold voltage of the MOSFET based on the derived drain and/or gate voltages and a predetermined threshold voltage.

13. A method for designing a semiconductor circuit device of claim 10, wherein a gate voltage and a drain voltage of a MOSFET are constant in the first functional circuit block, and the setting threshold voltages of MOSFETs in a first functional circuit block, comprising:
determining a threshold voltage of a MOSFET;
deriving a pair of a gate voltage and a drain voltage at which a temperature dependence of drain current of the MOSFET is substantially zero by changing a gate voltage and/or drain voltage at the determined threshold voltage;
determining gate size of the MOSFET based on the pair of a gate voltage and a drain voltage.

14. A method for designing a semiconductor circuit device of claim 10, comprising:
measuring a temperature dependence of a drain current and a threshold voltage of a MOSFET;
calculating a temperature dependence of a characteristic of the semiconductor circuit device at the drain current and the threshold voltage using a circuit simulator based on a resultant of the measuring a temperature dependence;
repeating the calculating at a different threshold voltage; and
determining a threshold voltage based on the calculated temperature dependences such that the characteristic of the semiconductor circuit device has a predetermined temperature dependence coefficient.

15. The method for designing a semiconductor circuit device of claim 14, further comprising:
determining gate size of the MOSFET, after the determining a threshold voltage, such that the characteristic of the semiconductor circuit device has a predetermined value.

16. The method for designing a semiconductor circuit device of claim 10, wherein the first functional circuit has a positive temperature dependence coefficient and the second functional circuit has a positive temperature dependence coefficient.

17. The method for designing a semiconductor circuit device of claim 16, wherein a temperature dependence coefficient of the first and the second functional circuit as a whole is substantially zero.

18. A method for designing a semiconductor circuit device including a NMOSFET and a PMOSSFET, comprising:
determining a NMOSFET threshold voltage such that a temperature dependence coefficient of an operating characteristic is a predetermined value;
determining a PMOSFET threshold voltage such that the temperature dependence coefficient of an operating characteristic is a predetermined value; and wherein
a upper limit of the upper absolute threshold voltage of the NMOSFET and the PMOSFET is defined by a condition regarding processing speed, and a lower limit of the lower absolute threshold voltage of the NMOSFET and the PMOSFET is defined by a condition regarding power consumption.

19. A semiconductor circuit device designed according to the method for designing of claim 1.

20. A semiconductor circuit device designed according to the method for designing of claim 10.

21. A semiconductor circuit device designed according to the method for designing of claim 18.

22. A semiconductor circuit device comprising:
a plurality of functional circuit blocks; and
an adjusting circuit adjusting a temperature dependence coefficient of an operating characteristic of a functional circuit block to a predetermined value.

23. The semiconductor circuit device of claim 22, wherein the adjusting circuit adjusts the temperature dependence coefficient to substantially zero.

24. The semiconductor circuit device of claim 22, wherein the adjusting circuit comprises a redundant circuit selectively connected to the functional circuit block to adjust the temperature dependence coefficient.

25. The semiconductor circuit device of claim 22, wherein the adjusting circuit controls a threshold voltage of a MOSFET in the functional circuit block.

26. The semiconductor circuit device of claim 22, wherein the adjusting circuit generates an internal voltage to the functional circuit block from an external voltage supply and controlling the internal voltage to adjust the temperature dependence coefficient.

27. The semiconductor circuit device of claim 26, wherein the adjusting circuit generates an internal voltage to another functional circuit block and controls the internal voltage to another functional circuit block to adjust a temperature dependence coefficient of an operating characteristic of the another functional circuit block.

28. The semiconductor circuit device of claim 26, wherein the adjusting circuit comprises a temperature detector and controls the internal voltage based on a detected temperature.
